(19) United States
(12) Patent Application Publication
(10) Pub. No.: US 2020/0018611 A1
(43) Pub. Date: Jan. 16, 2020

(54) APPARATUS AND METHOD FOR COLLECTING USER INTEREST INFORMATION

(71) Applicant: LG ELECTRONICS INC., Seoul (KR)

(72) Inventors: Min Kyu Park, Gimpo-si (KR); Ah Young Shin, Gimpo-si (KR)

(73) Assignee: LG ELECTRONICS INC., Seoul (KR)

(21) Appl. No.: 16/584,455

(22) Filed: Sep. 26, 2019

(30) Foreign Application Priority Data
Aug. 29, 2019 (KR) 10-2019-0106710

(51) Int. Cl. G01C 21/34; H04W 4/44; G05D 1/02; G06Q 30/02

(52) U.S. Cl. CPC G01C 21/3484; H04W 4/44; H04W 84/042; G01C 21/3415; G06Q 30/0201; G05D 1/0276

(57) ABSTRACT

An embodiment of the present disclosure is an apparatus for collecting user interest information which is provided with user interest information, which is an interest data collection reference, from an external server. The apparatus includes an object detector configured to acquire sensor data, a communicator configured to receive user interest information, a controller configured to set a data collection range on the basis of the user interest information, and select interest data from the sensor data in accordance with the data collection range. One or more of an autonomous driving vehicle, a user terminal, and a server of the present disclosure may be associated or combined with an artificial intelligence module, a drone (Unmanned Aerial Vehicle, UAV), a robot, an AR (Augmented Reality) device, a VR (Virtual Reality) device, a device associated with 5G services, etc.

### CROSS-REFERENCE TO RELATED APPLICATION

Pursuant to 35 U.S.C. § 119(a), this application claims the benefit of earlier filing date and right of priority to Korean Patent Application No. 10-2019-0106710, filed on Aug. 29, 2019, the contents of which are hereby incorporated by reference herein in its entirety.

### BACKGROUND

### 1. Technical Field

The present disclosure relates to an apparatus and method for collecting data, particularly, user interest information using a sensor mounted on a vehicle.

### 2. Description of Related Art

In general, recent vehicles are equipped with various sensors including a camera function and include a storage that stores sensor sensing data including image data acquired by the sensors.

The sensor sensing data acquired, as described above, can be collected as vehicle driving information by a server, etc., and the server can provide the collected information in accordance with a request from a user terminal or a vehicle.

However, when the sensor sensing data acquired, as described above, are recorded and transmitted as they are to the server, they may be a burden in terms of communication resources and storage space distribution due to the size.

As one of the methods of the related art for solving the problem with a vehicle-side storage capacity for sensor sensing data, as disclosed in Korean Patent No. 1096376, there is a method that can automatically store sensor data, which are collected from a vehicle, in a cloud server through a mobile terminal that can use the internet.

However, according to the existing method disclosed in Korean Patent No. 1096376 described above, the capacity problem with the storage of a vehicle can be solved, but the size of the sensor data themselves is still large, so there is a problem in that it is not preferable in terms of efficiency of communication resources and a server storage space.

Accordingly, there is a need for a technology that reduces transmission and storage capacity of data while keeping necessary information when collecting vehicle sensor data.

### SUMMARY OF THE INVENTION

An embodiment of the present disclosure provides an apparatus and method for collecting user interest information, the apparatus and method reducing a waste of resources by storing or transmitting only information, except for unnecessary data of a large number of data collected inside and outside a vehicle, to a server.

Further, an embodiment of the present disclosure has a purpose that provides an apparatus and method for collecting user interest information effectively preventing a waste of resources and protecting private information by sorting data in accordance with not only the location and time, but also the object type and by deleting private information that is sensitive to the sorted data when selecting interest data from collected sensor data.

Aspects of the present disclosure are not limited to the above-mentioned aspects, and other technical aspects not mentioned above will be clearly understood by those skilled in the art from the following description.

In order to achieve the objects described above, an apparatus for collecting user interest information according to an embodiment of the present disclosure can set a data collection range, which defines time, a location, and a type, and select and provide interest data in accordance with the set data collection range.

In detail, an embodiment of the present disclosure may be an apparatus for collecting user interest information which is provided with user interest information from an external server. The apparatus includes: an object detector configured to acquire sensor data; a communicator configured to receive user interest information; and a controller configured to set a data collection range on the basis of the user interest information, and select interest data from the sensor data in accordance with the data collection range, in which the controller transmits the interest data to the external server through the communicator, and the user interest information is information expressed as an architecture including a reference about data collection location, a reference about data collection time, and a reference about a collection data type on the basis of an interest field input by a user.

An embodiment of the present disclosure may be an apparatus for collecting user interest information in which the controller generates anonymous interest data obtained by anonymizing private information in the interest data and transmits the generated anonymous interest data to the external server through the communicator.

An embodiment of the present disclosure may be an apparatus for collecting user interest information in which when the collection data type is an object type and the object type is included in the sensor data, the controller selects the sensor data as the interest data.

An embodiment of the present disclosure may be an apparatus for collecting user interest information in which the communicator receives the user interest information on the basis of a downlink grant of a 5G network to which a vehicle is connected to operate in an autonomous driving mode.

An embodiment of the present disclosure may be an apparatus for collecting user interest information which is provided with interest data from a plurality of vehicles, the apparatus including: a communicator configured to receive an interest field input by a user, to transmit user interest information corresponding to the interest field input by the user, and to receive interest data corresponding to the user interest information; and a controller configured to generate the user interest information expressed as an architecture including a reference about data collection location, a reference about data collection time, and a reference about a collection data type on the basis of an interest field input by a user, and to provide the generated user interest information to the communicator.

An embodiment of the present disclosure may be an apparatus for collecting user interest information, the apparatus further including a storage configured to store a plurality of vehicle lists that agreed with collection of the interest data, in which the controller selects a data collection vehicle for interest data collection from a plurality of vehicles included in the plurality of vehicle lists on the basis of the reference about the data collection location and the reference about the data collection time, and transmits the user interest information to the selected data collection vehicle through the communicator.

An embodiment of the present disclosure may be an apparatus for collecting user interest information, in which the controller generates a route control signal changing the route of the data collection vehicle on the basis of the reference about a data collection location and the reference about data collection time, and transmits the generated route control signal to the data collection vehicle through the communicator.

An embodiment of the present disclosure may be an apparatus for collecting user interest information, in which when time taken by the data collection vehicle to arrive at a destination via a data collection location does not exceed time that is taken to arrive at the destination through a predetermined route, the controller generates a route control signal changing a route such that the data collection vehicle arrives at the destination via the data collection location, and transmits the generated route control signal to the data collection vehicle through the communicator.

An embodiment of the present disclosure may be a method for collecting user interest information which is provided with user interest information from an external server, the method including: receiving user interest information; setting a data collection range on the basis of the user interest information; acquiring sensor data; and selecting interest data from the sensor data in accordance with the data collection range, in which the user interest information is information expressed as an architecture including a reference about data collection location, a reference about data collection time, and a reference about a collection data type on the basis of an interest field input by a user.

An embodiment of the present disclosure may be a method for collecting user interest information further including: generating anonymous interest data obtained by anonymizing private information in the interest data; and transmitting the anonymous interest data to the external server.

An embodiment of the present disclosure may be a method for collecting user interest information in which when the collection data type is an object type and the object type is included in the sensor data, the selecting of interest data includes selecting the sensor data as the interest data.

An embodiment of the present disclosure may be a method for collecting user interest information in which the receiving of user interest information includes receiving the user interest information on the basis of a downlink grant of a 5G network to which a vehicle is connected to operate in an autonomous driving mode.

An embodiment of the present disclosure may be a method for collecting user interest information which is provided with interest data from a plurality of vehicles, the method including: receiving an interest field input by a user; generating the user interest information expressed as an architecture including a reference about data collection location, a reference about data collection time, and a reference about a collection data type on the basis of an interest field input by a user; transmitting the user interest information; and receiving interest data corresponding to the user interest information.

An embodiment of the present disclosure may be a method for collecting user interest information, the method further including storing a plurality of vehicle lists that agreed with collection of the interest data; and selecting a data collection vehicle for interest data collection from a plurality of vehicles included in the plurality of vehicle lists on the basis of the reference about the data collection location and the reference about the data collection time, in which the transmitting of user interest information includes transmitting the user interest information to the data collection vehicle.

An embodiment of the present disclosure may be a method for collecting user interest information, the method further including: generating a route control signal changing a route of the data collection vehicle on the basis of the reference about the data collection location and the reference about the data collection time, and transmitting the generated route control signal to the data collection vehicle.

An embodiment of the present disclosure may be a method for collecting user interest information, the method further including when time taken by the data collection vehicle to arrive at a destination via a data collection location does not exceed time that is taken to arrive at the destination through a predetermined route, generating a route control signal changing a route such that the data collection vehicle arrives at the destination via the data collection location, and transmits the generated route control signal to the data collection vehicle.

An embodiment of the present disclosure may be a computer-readable recording medium in which an user interest information collection program is recorded, the user interest information collection program causing a computer to perform: acquiring sensor data; receiving user interest information; setting a data collection range on the basis of the user interest information; and selecting interest data from the sensor data in accordance with the data collection range, in which the user interest information is information expressed as an architecture including a reference about data collection location, a reference about data collection time, and a reference about a collection data type on the basis of an interest field input by a user.

An embodiment of the present disclosure may be a computer-readable recording medium in which an user interest information collection program is recorded, the user interest information collection program causing a computer to perform: receiving an interest field input by a user; generating the user interest information expressed as an architecture including a reference about data collection location, a reference about data collection time, and a reference about a collection data type on the basis of an interest field input by a user; transmitting the user interest information; and receiving interest data corresponding to the user interest information.

Details of other embodiments are included in the detailed description and drawings.

According to an embodiment of the present disclosure, when there is an important situation change in a driving environment requiring management of a vehicle while a passenger plays a game, it is possible to effectively cope with the situation change without missing the time for managing the vehicle by controlling the vehicle through manipulation in the game.

According to an embodiment of the present disclosure, it is possible to accumulate intention determination history data about management of a vehicle by a passenger through an intention grasping game every time management of the vehicle is required, and to perform management of the vehicle corresponding to passenger's intention through the accumulated data.

Embodiments of the present disclosure are not limited to the embodiments described above, and other embodiments not mentioned above will be clearly understood from the description below.

### BRIEF DESCRIPTION OF THE DRAWINGS

FIG. 1 is a diagram showing a system to which an apparatus for collecting user interest information according to an embodiment of the present disclosure is applied;

FIG. 2 is a block diagram showing an apparatus for collecting user interest information according to an embodiment of the present disclosure installed in a vehicle;

FIG. 3 is a block diagram showing an apparatus for collecting user interest information according to an embodiment of the present disclosure installed in a user terminal;

FIG. 4 is a diagram showing an example of the basic operation of an autonomous vehicle and a 5G network in a 5G communication system.

FIG. 5 is a diagram showing an example of application operations of an autonomous vehicle and a 5G network in a 5G communication system.

FIGS. 6-9 are diagrams showing examples of the operation of an autonomous vehicle using 5G communication.

FIGS. 10 and 11 are operation flowcharts showing a method for collecting user interest information according to an embodiment of the present disclosure.

FIGS. 12A and 12B are diagrams showing a game execution screen of an apparatus for collecting user interest information according to an embodiment of the present disclosure.

### DETAILED DESCRIPTION

Hereinafter, exemplary embodiments disclosed the present invention will be described in detail with reference to the accompanying drawings, and the same or similar components are denoted by the same reference numerals regardless of reference numerals, and repeated description thereof will be omitted. In the following description, the terms “module” and “unit” for referring to elements are assigned and used exchangeably in consideration of convenience of explanation, and thus, the terms per se do not necessarily have different meanings or functions. In the following description of the embodiments disclosed herein, the detailed description of related known technology will be omitted when it may obscure the subject matter of the embodiments according to the present disclosure. The accompanying drawings are merely used to help easily understand embodiments of the present disclosure, and it should be understood that the technical idea of the present disclosure is not limited by the accompanying drawings, and these embodiments include all changes, equivalents or alternatives within the idea and the technical scope of the present disclosure.

It will be understood that, although the terms “first”, “second”, and the like may be used herein to describe various elements, these elements should not be limited by these terms. These terms are generally only used to distinguish one element from another.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present.

It must be noted that as used herein and in the appended claims, the singular forms “a,” “an,” and “the” include the plural references unless the context clearly dictates otherwise.

It should be understood that the terms “comprises,” “comprising,” “includes,” “including,” “containing,” “has,” “having” or any other variation thereof specify the presence of stated features, integers, steps, operations, elements, and/or components, but do not preclude the presence or addition of one or more other features, integers, steps, operations, elements, and/or components.

A vehicle described in this specification refers to a car, an automobile, and the like. Hereinafter, the vehicle will be exemplified as an automobile.

The vehicle described in the present specification may include, but is not limited to, a vehicle having an internal combustion engine as a power source, a hybrid vehicle having an engine and an electric motor as a power source, and an electric vehicle having an electric motor as a power source.

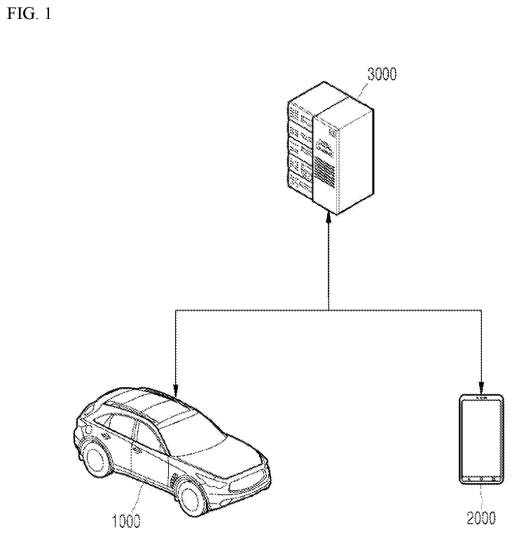

FIG. 1 is a diagram showing a system to which an apparatus for collecting user interest information according to an embodiment of the present disclosure is applied.

Referring to FIG. 1, a vehicle 1000 or a user terminal 2000 is connected with a server 3000 collecting and providing interest data corresponding to user interest information such that a person who possesses the vehicle 1000 or the user terminal 2000 can be provided with requested information.

The interest data means the entire or some of data that are requested by the server 3000 and can be collected in the vehicle 1000.

The interest data may include sound data, image data, and location information. The sound data may include sounds acquired in a predetermined area and sounds including the sounds of specific objects, for example, a wind sound, a wave sound, a horn sound, a train sound, etc. The image data may include images acquired in a predetermined area and images including the shapes of specific objects, for example, a tree, a building, a bridge, a bicycle, etc. The location information may include GPS (Global Positioning System) information in a predetermined area and predetermined time, for example, a GPS altitude in a predetermined section for checking a road state.

The user interest information, which is architectural data including references for collecting interest data in accordance with a request from a server 3000 including an affiliate server and a cloud server, the user terminal 2000, or the like, may include references about a data collection location, data collection time, and a collection data type. The data collection location may include a predetermined location, a predetermined section of a road reference, and an area within a predetermined radius from a predetermined location and may be set to be able to collect data at any places without a limitation in location. The data collection time may include predetermined time or may be set to be able to collect data anytime without a limitation in time. The collection data type may be full data including a sound, an image, and a location or data including object-related patterns, for example, a sound including a bird sound and an image including a bicycle.

The vehicle 1000 can set a start point and an end point of selecting interest data on the basis of user interest information. For example, when a data collection location is a predetermined location, the vehicle 1000 can start selection of interest data when the vehicle 1000 enters the corresponding location and can end selection of interest data when the vehicle 1000 comes out of the corresponding location.

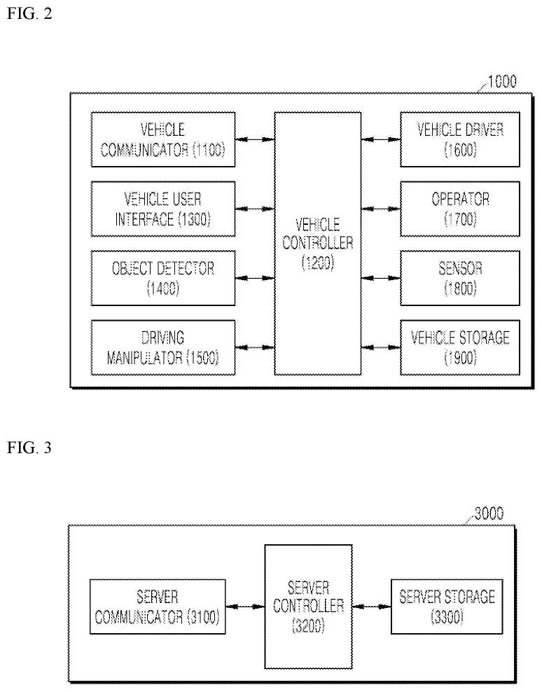

FIG. 2 is a block diagram showing an apparatus for collecting user interest information according to an embodiment of the present disclosure installed in a vehicle.

Referring to FIG. 2, an apparatus for collecting user interest information may include a vehicle communicator 1100, a vehicle controller 1200, a vehicle user interface 1300, an object detector 1400, a driving manipulator 1500, a vehicle driver 1600, an operator 1700, a sensor 1800, and a vehicle storage 1900.

Depending on embodiments, the vehicle 1000 to which the apparatus for collecting user interest information is applied may include constitute elements other than the components shown in FIG. 2 and to be described below or may not include some of the constitute elements shown in FIG. 2 and to be described below.

The vehicle 1000 may be switched from an autonomous driving mode to a manual mode, or switched from the manual mode to the autonomous driving mode depending on the driving situation. Here, the driving situation may be determined by any one of information received by the vehicle communicator 1100, external object information detected by the object detector 1400, and navigation information acquired by a navigation module.

The vehicle 1000 may be switched from the autonomous driving mode to the manual mode, or from the manual mode to the autonomous driving mode, according to a user input received through the user interface 1300.

When the vehicle 1000 is operated in the autonomous driving mode, the vehicle 1000 may be operated under the control of the operator 1700 that controls driving, parking, and unparking. When the vehicle 1000 is operated in the manual mode, the vehicle 1000 may be operated by an input of the driver's mechanical driving operation.

The vehicle communicator 1100 may be a module for performing communication with an external device. Here, the external device may be the user terminal 2000 or the server 3000.

The vehicle communicator 1100 can receive user interest information from the external server 3000 and can transmit interest data to the external server 3000.

The vehicle communicator 1100 may include at least one among a transmission antenna, a reception antenna, a radio frequency (RF) circuit capable of implementing various communication protocols, and an RF element in order to perform communication.

The vehicle communicator 1100 may perform short-range communication, GPS signal reception, V2X communication, optical communication, broadcast transmission/reception, and intelligent transport systems (ITS) communication functions.

The vehicle communicator 1100 may further support other functions than the functions described, or may not support some of the functions described, depending on the embodiment.

The vehicle communicator 1100 may support short-range communication by using at least one among Bluetooth™, Radio Frequency Identification (RFID), Infrared Data Association (IrDA), Ultra WideBand (UWB), ZigBee, Near Field Communication (NFC), Wireless-Fidelity (Wi-Fi), Wi-Fi Direct, and Wireless Universal Serial Bus (Wireless USB) technologies.

The vehicle communicator 1100 may form short-range wireless communication networks so as to perform short-range communication between the vehicle 1000 and at least one external device.

The vehicle communicator 1100 may include a Global Positioning System (GPS) module or a Differential Global Positioning System (DGPS) module for obtaining location information of the vehicle 1000.

The vehicle communicator 1100 may include a module for supporting wireless communication between the vehicle 1000 and a server 3000 (V2I: vehicle to infrastructure), communication with another vehicle (V2V: vehicle to vehicle) or communication with a pedestrian (V2P: vehicle to pedestrian). That is, the vehicle communicator 1100 may include a V2X communication module. The V2X communication module may include an RF circuit capable of implementing V21, V2V, and V2P communication protocols.

The vehicle communicator 1100 may receive a danger information broadcast signal transmitted by another vehicle through the V2X communication module, and may transmit a danger information inquiry signal and receive a danger information response signal in response thereto.

The vehicle communicator 1100 may include an optical communication module for performing communication with an external device via light. The optical communication module may include a light transmitting module for converting an electrical signal into an optical signal and transmitting the optical signal to the outside, and a light receiving module for converting the received optical signal into an electrical signal.

The light transmitting module may be formed to be integrated with the lamp included in the vehicle 1000.

The vehicle communicator 1100 may include a broadcast communication module for receiving broadcast signals from an external broadcast management server, or transmitting broadcast signals to the broadcast management server through broadcast channels. The broadcast channel may include a satellite channel and a terrestrial channel. Examples of the broadcast signal may include a TV broadcast signal, a radio broadcast signal, and a data broadcast signal.

The vehicle communicator 1100 may include an ITS communication module that exchanges information, data or signals with a traffic system. The ITS communication module may provide the obtained information and data to the traffic system. The ITS communication module may receive information, data, or signals from the traffic system. For example, the ITS communication module may receive road traffic information from the communication system and provide the road traffic information to the vehicle controller 1200. For example, the ITS communication module may receive control signals from the traffic system and provide the control signals to the vehicle controller 1200 or a processor provided in the vehicle 1000.

Depending on the embodiment, the overall operation of each module of the vehicle communicator 1100 may be controlled by a separate process provided in the vehicle communicator 1100. The vehicle communicator 1100 may include a plurality of processors, or may not include a processor. When a processor is not included in the vehicle communicator 1100, the vehicle communicator 1100 may be operated by either a processor of another apparatus in the vehicle 1000 or the vehicle controller 1200.

The vehicle communicator 1100 may, together with the vehicle user interface 1300, implement a vehicle-use display device. In this case, the vehicle-use display device may be referred to as a telematics device or an audio video navigation (AVN) device.

The vehicle communicator 1100 can receive vehicle information including user interest information on the basis of a downlink grant of a 5G network to which the vehicle 1000 is connected to operate in the autonomous driving mode.

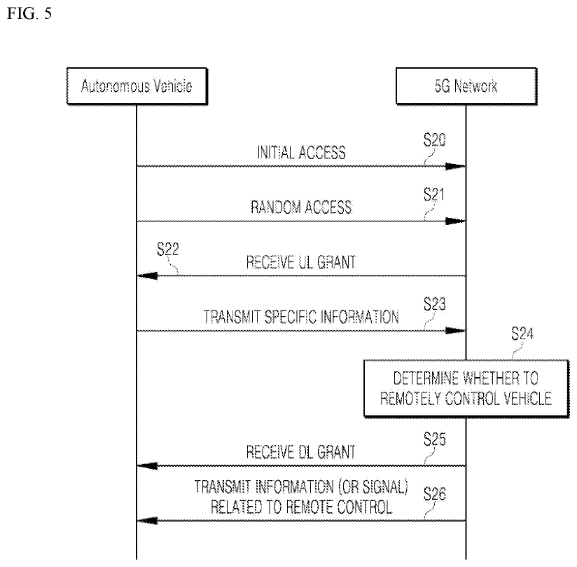

FIG. 4 is a diagram showing an example of the basic operation of an autonomous vehicle and a 5G network in a 5G communication system.

The vehicle communicator 1100 may transmit specific information over a 5G network when the vehicle 1000 is operated in the autonomous driving mode.

The specific information may include autonomous driving-related information.

The autonomous driving related information may be information directly related to the driving control of the vehicle. For example, the autonomous driving-related information may include at least one among object data indicating an object near the vehicle, map data, vehicle status data, vehicle location data, and driving plan data.

The autonomous driving related information may further include service information necessary for autonomous driving. For example, the specific information may include information on a destination inputted through the user terminal 1300 and a safety rating of the vehicle.

In addition, the 5G network may determine whether a vehicle is to be remotely controlled (S2).

The 5G network may include a server or a module for performing remote control related to autonomous driving.

The 5G network may transmit information (or a signal) related to the remote control to an autonomous driving vehicle (S3).

As described above, information related to the remote control may be a signal directly applied to the autonomous driving vehicle, and may further include service information necessary for autonomous driving, such as driving information. The autonomous driving vehicle according to this embodiment may receive service information such as insurance for each interval selected on a driving route and risk interval information, through a server connected to the 5G network to provide services related to the autonomous driving.

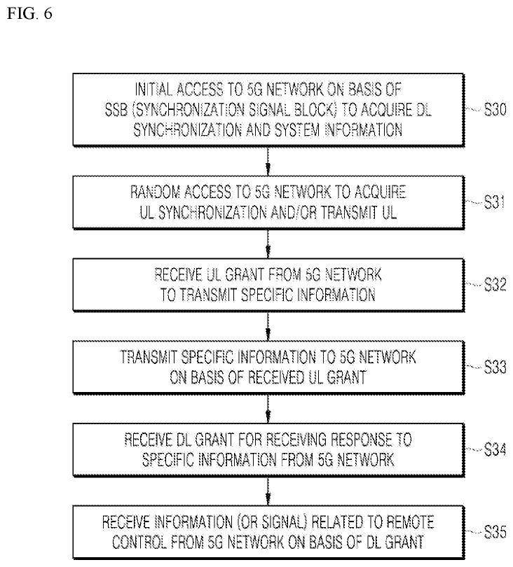

An essential process for performing 5G communication between the autonomous driving vehicle 1000 and the 5G network (for example, an initial access process between the vehicle 1000 and the 5G network) will be briefly described with reference to FIG. 5 to FIG. 9 below.

An example of application operations through the autonomous driving vehicle 1000 performed in the 5G communication system and the 5G network is as follows.

The vehicle 1000 may perform an initial access process with the 5G network (initial access step, S20). In this case, the initial access procedure includes a cell search process for acquiring downlink (DL) synchronization and a process for acquiring system information.

The vehicle 1000 may perform a random access process with the 5G network (random access step, S21). At this time, the random access procedure includes an uplink (UL) synchronization acquisition process or a preamble transmission process for UL data transmission, a random access response reception process, and the like.

The 5G network may transmit an Uplink (UL) grant for scheduling transmission of specific information to the autonomous driving vehicle 1000 (UL grant receiving step, S22).

The procedure by which the vehicle 1000 receives the UL grant includes a scheduling process in which a time/frequency resource is allocated for transmission of UL data to the 5G network.

The autonomous driving vehicle 1000 may transmit specific information over the 5G network based on the UL grant (specific information transmission step, S23).

The 5G network may determine whether the vehicle 1000 is to be remotely controlled based on the specific information transmitted from the vehicle 1000 (vehicle remote control determination step, S24).

The autonomous driving vehicle 1000 may receive the DL grant through a physical DL control channel for receiving a response on pre-transmitted specific information from the 5G network (DL grant receiving step, S25).

The 5G network may transmit information (or a signal) related to the remote control to the autonomous driving vehicle 1000 based on the DL grant (remote control related information transmission step, S26).

A process in which the initial access process and/or the random access process between the 5G network and the autonomous driving vehicle 1000 is combined with the DL grant receiving process has been exemplified. However, the present disclosure is not limited thereto.

For example, an initial access procedure and/or a random access procedure may be performed through an initial access step, an UL grant reception step, a specific information transmission step, a remote control decision step of the vehicle, and an information transmission step associated with remote control. In addition, for example, the initial access process and/or the random access process may be performed through the random access step, the UL grant receiving step, the specific information transmission step, the vehicle remote control determination step, and the remote control related information transmission step. The autonomous driving vehicle 1000 may be controlled by the combination of an AI operation and the DL grant receiving process through the specific information transmission step, the vehicle remote control determination step, the DL grant receiving step, and the remote control related information transmission step.

The operation of the autonomous driving vehicle 1000 described above is merely exemplary, but the present disclosure is not limited thereto.

For example, the operation of the autonomous driving vehicle 1000 may be performed by selectively combining the initial access step, the random access step, the UL grant receiving step, or the DL grant receiving step with the specific information transmission step, or the remote control related information transmission step. The operation of the autonomous driving vehicle 1000 may include the random access step, the UL grant receiving step, the specific information transmission step, and the remote control related information transmission step. The operation of the autonomous driving vehicle 1000 may include the initial access step, the random access step, the specific information transmission step, and the remote control related information transmission step. The operation of the autonomous driving vehicle 1000 may include the UL grant receiving step, the specific information transmission step, the DL grant receiving step, and the remote control related information transmission step.

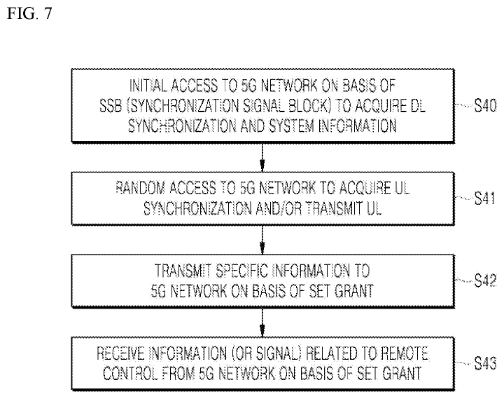

As illustrated in FIG. 6, the vehicle 1000 including an autonomous driving module may perform an initial access process with the 5G network based on Synchronization Signal Block (SSB) in order to acquire DL synchronization and system information (initial access step, S30).

The autonomous driving vehicle 1000 may perform a random access process with the 5G network for UL synchronization acquisition and/or UL transmission (random access step, S31).

The autonomous driving vehicle 1000 may receive the UL grant from the 5G network for transmitting specific information (UL grant receiving step, S32).

The autonomous driving vehicle 1000 may transmit the specific information to the 5G network based on the UL grant (specific information transmission step, S33).

The autonomous driving vehicle 1000 may receive the DL grant from the 5G network for receiving a response to the specific information (DL grant receiving step, S34).

The autonomous driving vehicle 1000 may receive remote control related information (or a signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. QCL (Quasi Co-Located) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

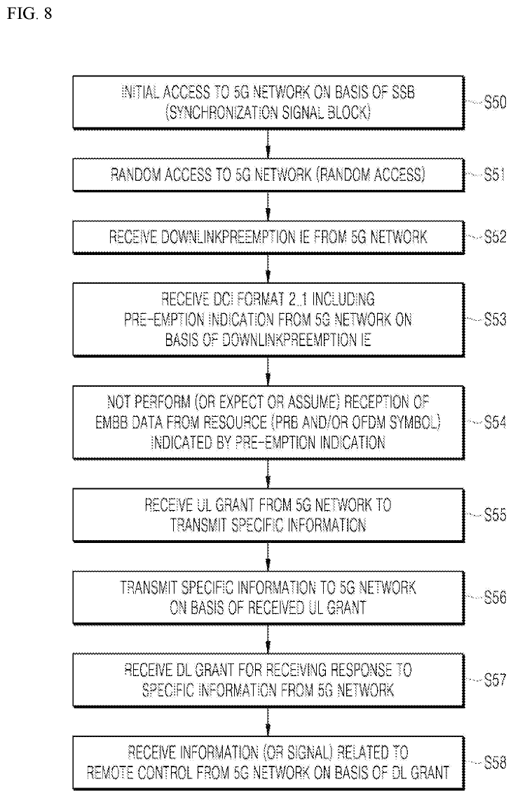

As illustrated in FIG. 7, the autonomous driving vehicle 1000 may perform an initial access process with the 5G network based on SSB for acquiring DL synchronization and system information (initial access step, S40).

The autonomous driving vehicle 1000 may perform a random access process with the 5G network for UL synchronization acquisition and/or UL transmission (random access step, S41).

The autonomous driving vehicle 1000 may transmit specific information based on a configured grant to the 5G network (UL grant receiving step, S42). In other words, instead of receiving the UL grant from the 5G network, the configured grant may be received.

The autonomous driving vehicle 1000 may receive the remote control related information (or a signal) from the 5G network based on the configured grant (remote control related information receiving step, S43).

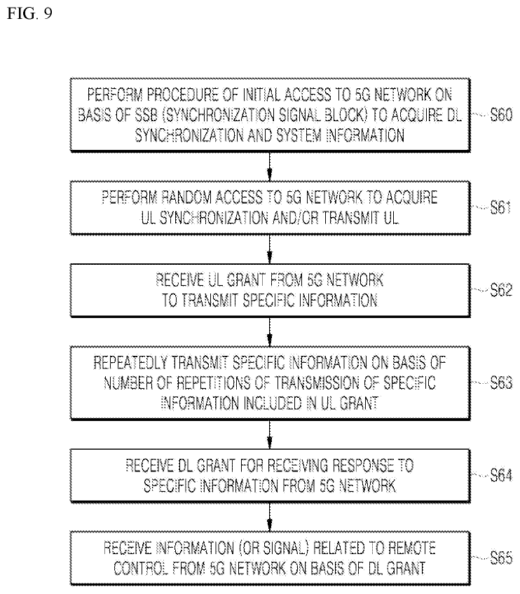

As illustrated in FIG. 8, the autonomous driving vehicle 1000 may perform an initial access process with the 5G network based on SSB for acquiring DL synchronization and system information (initial access step, S50).

The autonomous driving vehicle 1000 may perform a random access process with the 5G network for UL synchronization acquisition and/or UL transmission (random access step, S51).

In addition, the autonomous driving vehicle 1000 may receive Downlink Preemption (DL) and Information Element (IE) from the 5G network (DL Preemption IE reception step, S52).

The autonomous driving vehicle 1000 may receive DCI (Downlink Control Information) format 2_1 including preemption indication based on the DL preemption IE from the 5G network (DCI format 2_1 receiving step, S53).

The autonomous driving vehicle 1000 may not perform (or expect or assume) the reception of eMBB data in the resource (PRB and/or OFDM symbol) indicated by the preemption indication (step of not receiving eMBB data, S54).

The autonomous driving vehicle 1000 may receive the UL grant over the 5G network for transmitting specific information (UL grant receiving step, S55).

The autonomous driving vehicle 1000 may transmit the specific information to the 5G network based on the UL grant (specific information transmission step, S56).

The autonomous driving vehicle 1000 may receive the DL grant from the 5G network for receiving a response to the specific information (DL grant receiving step, S57).

The autonomous driving vehicle 1000 may receive the remote control related information (or signal) from the 5G network based on the DL grant (remote control related information receiving step, S58).

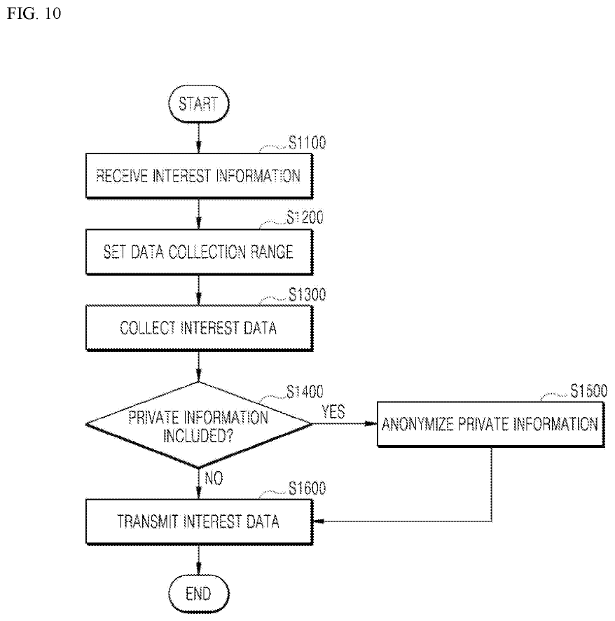

As illustrated in FIG. 9, the autonomous driving vehicle 1000 may perform an initial access process with the 5G network based on SSB for acquiring DL synchronization and system information (initial access step, S60).

The autonomous driving vehicle 1000 may perform a random access process with the 5G network for UL synchronization acquisition and/or UL transmission (random access step, S61).

The autonomous driving vehicle 1000 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous driving vehicle 1000 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of Resource Block (6RB) and Resource Block (1RB).

The autonomous driving vehicle 1000 may receive the DL grant from the 5G network for receiving a response to the specific information (DL grant receiving step, S64).

The autonomous driving vehicle 1000 may receive the remote control related information (or signal) from the 5G network based on the DL grant (remote control related information receiving step, S65).

The above-described 5G communication technique can be applied in combination with the embodiment proposed in this specification, which will be described in FIG. 1 to FIG. 12B, or supplemented to specify or clarify the technical feature of the embodiment proposed in this specification.

The vehicle 1000 may be connected to an external server through a communication network, and may be capable of moving along a predetermined route without a driver's intervention by using an autonomous driving technique.

In the following embodiments, the user may be interpreted as a driver, a passenger, or the owner of a user terminal.

While the vehicle 1000 is driving in the autonomous driving mode, the type and frequency of accident occurrence may depend on the capability of the vehicle 1000 of sensing dangerous elements in the vicinity in real time. The route to the destination may include sectors having different levels of risk due to various causes such as weather, terrain characteristics, traffic congestion, and the like.

At least one among an autonomous driving vehicle, a user terminal, and a server according to embodiments of the present disclosure may be associated or integrated with an artificial intelligence module, a drone (unmanned aerial vehicle (UAV)), a robot, an augmented reality (AR) device, a virtual reality (VR) device, a 5G service related device, and the like.

For example, the vehicle 1000 may operate in association with at least one artificial intelligence module or robot included in the vehicle 1000 in the autonomous driving mode.

For example, the vehicle 1000 may interact with at least one robot. The robot may be an autonomous mobile robot (AMR) capable of driving by itself. Being capable of driving by itself, the AMR may freely move, and may include a plurality of sensors so as to avoid obstacles during traveling. The AMR may be a flying robot (such as a drone) equipped with a flight device. The AMR may be a wheel-type robot equipped with at least one wheel, and which is moved through the rotation of the at least one wheel. The AMR may be a leg-type robot equipped with at least one leg, and which is moved using the at least one leg.

The robot may function as a device that enhances the convenience of a user of a vehicle. For example, the robot may move a load placed in the vehicle 1000 to a final destination. For example, the robot may perform a function of providing route guidance to a final destination to a user who alights from the vehicle 1000. For example, the robot may perform a function of transporting the user who alights from the vehicle 1000 to the final destination

At least one electronic apparatus included in the vehicle 1000 may communicate with the robot through a communication device.

At least one electronic apparatus included in the vehicle 1000 may provide, to the robot, data processed by the at least one electronic apparatus included in the vehicle 1000. For example, at least one electronic apparatus included in the vehicle 1000 may provide, to the robot, at least one among object data indicating an object near the vehicle, HD map data, vehicle status data, vehicle position data, and driving plan data.

At least one electronic apparatus included in the vehicle 1000 may receive, from the robot, data processed by the robot. At least one electronic apparatus included in the vehicle 1000 may receive at least one among sensing data sensed by the robot, object data, robot status data, robot location data, and robot movement plan data.

At least one electronic apparatus included in the vehicle 1000 may generate a control signal based on data received from the robot. For example, at least one electronic apparatus included in the vehicle may compare information on the object generated by an object detection device with information on the object generated by the robot, and generate a control signal based on the comparison result. At least one electronic device included in the vehicle 1000 may generate a control signal so as to prevent interference between the route of the vehicle and the route of the robot.

At least one electronic apparatus included in the vehicle 1000 may include a software module or a hardware module for implementing an artificial intelligence (AI) (hereinafter referred to as an artificial intelligence module). At least one electronic device included in the vehicle may input the acquired data to the AI module, and use the data which is outputted from the AI module.

The artificial intelligence module may perform machine learning of input data by using at least one artificial neural network (ANN). The artificial intelligence module may output driving plan data through machine learning of input data.

At least one electronic apparatus included in the vehicle 1000 may generate a control signal based on the data outputted from the artificial intelligence module.

According to the embodiment, at least one electronic apparatus included in the vehicle 1000 may receive data processed by an artificial intelligence from an external device through a communication device. At least one electronic apparatus included in the vehicle may generate a control signal based on the data processed by the artificial intelligence.

The vehicle controller 1200 can receive a control signal of an autonomous driving control server through the vehicle communicator 1100 and can control the autonomous driving mode operation in accordance with the control signal.

The vehicle controller 1200 can set a data collection range on the basis of user interest information provided from the external server 3000.

The vehicle controller 1200 may include a data acquisition module that selects interest data from sensor data acquired through the object detector 1400 in accordance with the data collection range. Here, the data acquisition module may be a module included in the vehicle controller 1200 but may be provided as a module separate from the vehicle controller 1200 and can provide selected interest data to the vehicle controller 1200.

The vehicle controller 1200 can generate anonymous interest data obtained by anonymizing private information in interest data and can transmit the generated anonymous interest data to the external server 3000 through the vehicle communicator 1100. That is, the vehicle controller 1200 can check whether private information is included in interest data and can mask the checked private information.

When a collection data type is an object type such as wind and a bicycle and the object type is included in sensor data, the data acquisition module of the vehicle controller 1200 can select the sensor data as interest data. When a data collection location is a limited place, the data acquisition module of the vehicle controller 1200 can check whether the location at which the vehicle 1000 currently is driven is the corresponding place, and the vehicle controller 1200 can select sensor data acquired when the driving location is the corresponding place as interest data.

When a passenger sets user interest information in person through the vehicle user interface 1300, the vehicle controller 1200 collects interest data and stores interest data in the vehicle storage 1900 on the basis of the set user interest information and can provide the collected interest data to the passenger through the vehicle user interface 1300.

The vehicle controller 1200 can check whether there is user interest information set by a passenger and collect interest data in accordance with the checked user interest information.

The vehicle controller 1200, depending selection by a passenger, may not collect interest data while currently driving, in the interest data collection manner, or may collect interest data but disallow a change of the route of the vehicle due to data collection, or may collect interest data and also allow for a change of the route of the vehicle due to data collection.

The vehicle controller 1200 may be implemented using at least one among application specific integrated circuits (ASICs), digital signal processors (DSPs), digital signal processing devices (DSPDs), programmable logic devices (PLDs), field [programmable gate arrays (FPGAs), processors, controllers, micro-controllers, microprocessors, and other electronic units for performing other functions.

The vehicle user interface 1300 may allow interaction between the vehicle 1000 and a vehicle user, receive an input signal of the user, transmit the received input signal to the vehicle controller 1200, and provide information included in the vehicle 1000 to the user under the control of the vehicle controller 1200.

The vehicle user interface 1300 can receive a user input signal and transmit a user input signal to the vehicle controller 1200 and can provide an interface for inputting an interest data request signal.

The vehicle user interface 1300 may include, but is not limited to, an input module, an internal camera, a bio-sensing module, and an output module.

The input module is for receiving information from a user. The data collected by the input module may be analyzed by the vehicle controller 1200 and processed by the user's control command.

The input module may receive the destination of the vehicle 1000 from the user and provide the destination to the controller 1200.

The input module may input to the vehicle controller 1200 a signal for designating and deactivating at least one of the plurality of sensor modules of the object detector 1400 according to the user's input.

The input module may be disposed inside the vehicle. For example, the input module may be disposed in one area of a steering wheel, one area of an instrument panel, one area of a seat, one area of each pillar, one area of a door, one area of a center console, one area of a head lining, one area of a sun visor, one area of a windshield, or one area of a window.

The output module is for generating an output related to visual, auditory, or tactile information. The output module may output a sound or an image.

The output module may include at least one of a display module, an acoustic output module, and a haptic output module.

The display module may display graphic objects corresponding to various information.

The display module may including at least one of a liquid crystal display (LCD), a thin film transistor liquid crystal display (TFT LCD), an organic light emitting diode (OLED), a flexible display, a 3D display, or an e-ink display.

The display module may form an interactive layer structure with a touch input module, or may be integrally formed with the touch input module to implement a touch screen.

The display module may be implemented as a head up display (HUD). When the display module is implemented as an HUD, the display module may include a project module, and output information through an image projected onto a windshield or a window.

The display module may include a transparent display. The transparent display may be attached to the windshield or the window.

The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted.

The vehicle user interface 1300 may include a plurality of display modules.

The display module may be disposed in one area of the steering wheel, one area of the instrument panel, one area of the seat, one area of each pillar, one area of the door, one area of the center console, one area of the head lining, or one area of the sun visor, or may be implemented on one area of the windshield or one area of the window.

The sound output module may convert an electrical signal provided from the vehicle controller 1200 into an audio signal. The sound output module may include at least one speaker.

The haptic output module may generate a tactile output. For example, the haptic output module may operate to allow the user to perceive the output by vibrating a steering wheel, a seat belt, and a seat.

The object detector 1400 is for detecting an object located outside the vehicle 1000. The object detector may generate object information based on the sensing data, and transmit the generated object information to the vehicle controller 1200. Examples of the object may include various objects related to the driving of the vehicle 1000, such as a lane, another vehicle, a pedestrian, a motorcycle, a traffic signal, light, a road, a structure, a speed bump, a landmark, and an animal.

The object detector 1400 may include a camera module, a lidar (light imaging detection and ranging), an ultrasonic sensor, a radar (radio detection and ranging), and an infrared sensor as a plurality of sensor modules.

The object detector 1400 can acquire sensor data around the vehicle 1000 for selecting interest data through the plurality of sensor modules.

Depending on the embodiment, the object detector 1400 may further include components other than the components described, or may not include some of the components described.

The radar may include an electromagnetic wave transmitting module and an electromagnetic wave receiving module. The radar may be implemented using a pulse radar method or a continuous wave radar method in terms of radio wave emission principle. The radar may be implemented using a frequency modulated continuous wave (FMCW) method or a frequency shift keying (FSK) method according to a signal waveform in a continuous wave radar method.

The radar may detect an object based on a time-of-flight (TOF) method or a phase-shift method using an electromagnetic wave as a medium, and detect the location of the detected object, the distance to the detected object, and the relative speed of the detected object.

The radar may be disposed at an appropriate position outside the vehicle for sensing an object disposed at the front, back, or side of the vehicle.

The lidar may include a laser transmitting module, and a laser receiving module. The lidar may be embodied using the time of flight (TOF) method or in the phase-shift method.

The lidar may be implemented using a driving method or a non-driving method.

When the lidar is embodied in the driving method, the lidar may rotate by means of a motor, and detect an object near the vehicle 1000. When the lidar is implemented in the non-driving method, the lidar may detect an object within a predetermined range with respect to the vehicle 1000 by means of light steering. The vehicle 1000 may include a plurality of non-driven type lidars.

The lidar may detect an object using the time of flight (TOF) method or the phase-shift method using laser light as a medium, and detect the location of the detected object, the distance from the detected object and the relative speed of the detected object.

The lidar may be disposed at an appropriate position outside the vehicle for sensing an object disposed at the front, back, or side of the vehicle.

An imager may be positioned at an appropriate position outside the vehicle, for example, the front, the rear, the right side view mirror, and the left side view mirror of the vehicle to acquire images outside the vehicle. The imager may be a mono camera but is not limited thereto and may be a stereo camera, an AVM (Around View Monitoring) camera, a 360-degree camera.

The imager may be disposed in proximity to the front windshield inside the vehicle in order to acquire front view images of the vehicle. Alternatively, the imager may be disposed near a front bumper or a radiator grill.

The imager may be disposed in proximity to a rear glass inside the vehicle in order to acquire rear view images of the vehicle. Alternatively, the imager may be disposed near a rear bumper, a trunk or a tail gate.

The imager may be disposed in proximity to at least one of side windows inside the vehicle in order to acquire side view images of the vehicle. Further, the imager may be disposed near a fender or a door.

The ultrasonic sensor may include an ultrasonic transmitting module, and an ultrasonic receiving module. The ultrasonic sensor may detect an object based on ultrasonic waves, and detect the location of the detected object, the distance from the detected object, and the relative speed of the detected object.

The ultrasonic sensor may be disposed at an appropriate position outside the vehicle for sensing an object at the front, back, or side of the vehicle.

The infrared sensor may include an infrared transmitting module, and an infrared receiving module. The infrared sensor may detect an object based on infrared light, and detect the location of the detected object, the distance from the detected object, and the relative speed of the detected object.

The infrared sensor may be disposed at an appropriate position outside the vehicle for sensing an object at the front, back, or side of the vehicle.

The vehicle controller 1200 may control the overall operation of the object detector 1400.

The vehicle controller 1200 may compare data sensed by the radar, the lidar, the ultrasonic sensor, and the infrared sensor with pre-stored data so as to detect or classify an object.

The vehicle controller 1200 may detect an object and perform tracking of the object based on the obtained image. The vehicle controller 1200 may perform operations such as calculation of the distance from an object and calculation of the relative speed of the object through image processing algorithms.

For example, the vehicle controller 1200 may obtain the distance information from the object and the relative speed information of the object from the obtained image based on the change of size of the object over time.

For example, the vehicle controller 1200 may obtain the distance information from the object and the relative speed information of the object through, for example, a pin hole model and road surface profiling.

The vehicle controller 1200 may detect an object and perform tracking of the object based on the reflected electromagnetic wave reflected back from the object. The vehicle controller 1200 may perform operations such as calculation of the distance to the object and calculation of the relative speed of the object based on the electromagnetic waves.

The vehicle controller 1200 may detect an object, and perform tracking of the object based on the reflected laser light reflected back from the object. Based on the laser light, the vehicle controller 1200 may perform operations such as calculation of the distance to the object and calculation of the relative speed of the object based on the laser light.

The vehicle controller 1200 may detect an object and perform tracking of the object based on the reflected ultrasonic wave reflected back from the object. The vehicle controller 1200 may perform operations such as calculation of the distance to the object and calculation of the relative speed of the object based on the reflected ultrasonic wave.

The vehicle controller 1200 may detect an object and perform tracking of the object based on the reflected infrared light reflected back from the object. The vehicle controller 1200 may perform operations such as calculation of the distance to the object and calculation of the relative speed of the object based on the infrared light.

Depending on the embodiment, the object detector 1400 may include a separate processor from the vehicle processor 1200. In addition, the radar, the lidar, the ultrasonic sensor, and the infrared sensor may each include a processor.

When a processor is included in the object detector 1400, the object detector 1400 may be operated under the control of the processor controlled by the vehicle controller 1200.

The driving manipulator 1500 may receive a user input for driving. In a manual mode, the vehicle 1000 may be driven on the basis of a signal provided by the driving manipulator 1500.

The vehicle driver 1600 may electrically control the driving of various apparatuses in the vehicle 1000. The vehicle driver 1600 can electrically control the operation of the powertrain, the chassis, the doors/windows, the safety devices, the lamps, and the air conditioner.

The operator 1700 may control various operations of the vehicle 1000. The operator 1700 may operate in the autonomous driving mode.

The operator 1700 can operate the vehicle 1000 in accordance with a vehicle control signal generated by the vehicle controller 1200 on the basis of an intention grasping game, an estimation model, or a database stored in the vehicle storage 1900.

The operator 1700 may include a driving module, an unparking module, and a parking module.

Depending on the embodiment, the operator 1700 may further include constituent elements other than the constituent elements to be described, or may not include some of the constitute elements.

The operator 1700 may include a processor under the control of the vehicle controller 1200. Each module of the operator 1700 may include a processor individually.

Depending on the embodiment, when the operator 1700 is implemented as software, it may be a sub-concept of the vehicle controller 1200.

The driving module may perform driving of the vehicle 1000.

The driving module may receive object information from the object detector 1400, and provide a control signal to a vehicle driving module to perform the driving of the vehicle 1000.

The driving module may receive a signal from an external device through the vehicle communicator 1100, and provide a control signal to the vehicle driving module, so that the driving of the vehicle 1000 may be performed.

In the unparking module, unparking of the vehicle 1000 may be performed.

The unparking module may receive navigation information from the navigation module, and provide a control signal to the vehicle driving module to perform the departure of the vehicle 1000.

In the unparking module, object information may be received from the object detector 1400, and a control signal may be provided to the vehicle driving module, so that the unparking of the vehicle 1000 may be performed.

In the unparking module, a signal may be provided from an external device through the vehicle communicator 1100, and a control signal may be provided to the vehicle driving module, so that the unparking of the vehicle 1000 may be performed.

In the parking module, parking of the vehicle 1000 may be performed.

The parking module may receive navigation information from the navigation module, and provide a control signal to the vehicle driving module to perform the parking of the vehicle 1000.

In the parking module, object information may be provided from the object detector 1400, and a control signal may be provided to the vehicle driving module, so that the parking of the vehicle 1000 may be performed.

In the parking module, a signal may be provided from the external device through the vehicle communicator 1100, and a control signal may be provided to the vehicle driving module so that the parking of the vehicle 1000 may be performed.

The navigation module may provide the navigation information to the vehicle controller 1200. The navigation information may include at least one of map information, set destination information, route information according to destination setting, information about various objects on the route, lane information, or current location information of the vehicle.

The navigation module may provide the vehicle controller 1200 with a parking lot map of the parking lot entered by the vehicle 1000. When the vehicle 1000 enters the parking lot, the vehicle controller 1200 receives the parking lot map from the navigation module, and projects the calculated route and fixed identification information on the provided parking lot map so as to generate the map data.

The navigation module may include a memory. The memory may store navigation information. The navigation information may be updated by information received through the vehicle communicator 1100. The navigation module may be controlled by an internal processor, or may operate by receiving an external signal, for example, a control signal from the vehicle controller 1200, but the present disclosure is not limited thereto.

The driving module of the operator 1700 may be provided with the navigation information from the navigation module, and may provide a control signal to the vehicle driving module so that driving of the vehicle 1000 may be performed.

The sensor 1800 may sense the state of the vehicle 1000 using a sensor mounted on the vehicle 1000, that is, a signal related to the state of the vehicle 1000, and obtain movement route information of the vehicle 1000 according to the sensed signal. The sensor 1800 may provide the obtained movement route information to the vehicle controller 1200.

The sensor 1800 may include a posture sensor (for example, a yaw sensor, a roll sensor, and a pitch sensor), a collision sensor, a wheel sensor, a speed sensor, a tilt sensor, a weight sensor, a heading sensor, a gyro sensor, a position module, a vehicle forward/reverse movement sensor, a battery sensor, a fuel sensor, a tire sensor, a steering sensor by rotation of a steering wheel, a vehicle interior temperature sensor, a vehicle interior humidity sensor, an ultrasonic sensor, an illuminance sensor, an accelerator pedal position sensor, and a brake pedal position sensor, but is not limited thereto.

The sensor 1800 may acquire sensing signals for information such as vehicle posture information, vehicle collision information, vehicle direction information, vehicle position information (GPS information), vehicle angle information, vehicle speed information, vehicle acceleration information, vehicle tilt information, vehicle forward/reverse movement information, battery information, fuel information, tire information, vehicle lamp information, vehicle interior temperature information, vehicle interior humidity information, a steering wheel rotation angle, vehicle exterior illuminance, pressure on an acceleration pedal, and pressure on a brake pedal.

The sensor 1800 may further include an acceleration pedal sensor, a pressure sensor, an engine speed sensor, an air flow sensor (AFS), an air temperature sensor (ATS), a water temperature sensor (WTS), a throttle position sensor (TPS), a TDC sensor, a crank angle sensor (CAS), but is not limited thereto.

The sensor 1800 may generate vehicle status information based on sensing data. The vehicle state information may be information generated based on data sensed by various sensors included in the inside of the vehicle.

The vehicle status information may include at least one among posture information of the vehicle, speed information of the vehicle, tilt information of the vehicle, weight information of the vehicle, direction information of the vehicle, battery information of the vehicle, fuel information of the vehicle, tire air pressure information of the vehicle, steering information of the vehicle, vehicle interior temperature information, vehicle interior humidity information, pedal position information, and vehicle engine temperature information.

The vehicle storage 1900 may be electrically connected to the vehicle controller 1200. The vehicle storage 1900 can store basic data of each part of an apparatus for collecting user interest information, control data for operation control of the parts of the apparatus for collecting user interest information, and input/output data.

The vehicle storage 1900 can store a user input signal, which is input while the intention grasping game is executed, and vehicle information matched with the user input signal, and can provide the stored data to the vehicle controller 1200 in accordance with control by the vehicle controller 1200.

The vehicle storage 1900 can store an estimation model machine-learned to estimate user's intention for vehicle management.

The vehicle storage 1900 may be various storage devices such as a ROM, a RAM, an EPROM, a flash drive, and a hard drive, in terms of hardware. The vehicle storage 1900 may store various data for overall operation of the vehicle 1000, such as a program for processing or controlling the vehicle controller 1200, in particular driver propensity information. The vehicle storage 1900 may be integrally formed with the vehicle controller 1200, or implemented as a sub-component of the vehicle controller 1200.

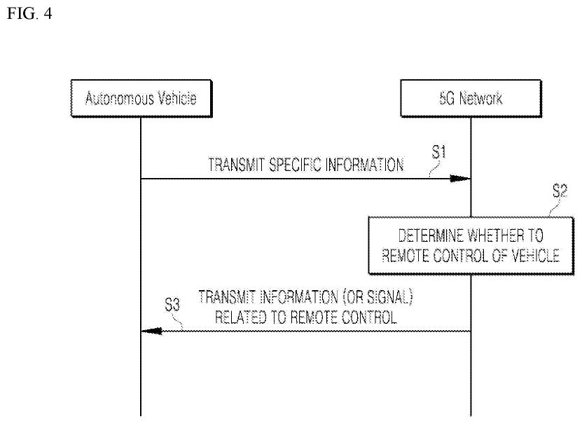

FIG. 3 is a block diagram showing an apparatus for collecting user interest information according to an embodiment of the present disclosure installed in a server.

Referring to FIG. 3, the apparatus for collecting user interest information may include a server communicator 3100, a server controller 3200, and a server storage 3300.

Depending on embodiments, the vehicle 3000 to which the apparatus for collecting user interest information is applied may include constitute elements other than the constitute elements shown in FIG. 3 and to be described below or may not include some of the constitute elements shown in FIG. 3 and to be described below.

The server communicator 3100 is a module for performing communication with an external device. Here, the external device may be the user terminal 2000 or the vehicle 1000.

The server communicator 3100 can receive an interest field input by a user from the user terminal 2000 or the vehicle 1000, transmit user interest information corresponding to the interest field input by the user to a plurality of vehicles including the vehicle 1000, and receive interest data corresponding to the user interest information from the plurality of vehicles including the vehicle 1000.

The server communicator 3100 may include at least any one of a transmission antenna, a reception antenna, an RF circuit which can implement various communication protocols, and an RF element in order to perform communication.

The server communicator 3100 can support short-range communication using at least one of Bluetooth, RFID, infrared communication, UWB, ZigBee, NFC, Wi-Fi, Wi-Fi Direct, and Wireless USB technologies.

The server controller 3200 can generate user interest information expressed as an architecture including a reference about a data collection location, a reference about data collection time, and a reference about a collection data type on the basis of an interest field input by a user and received through the server communicator 3100, and can provide the generated user interest information to the server communicator 3100.

The server controller 3200 can select a data collection vehicle for interest data collection of a plurality of vehicles included in a plurality of vehicle lists stored in the server storage 3300 on the basis of the reference about a data collection location and the reference about data collection time of the user interest information, and can transmit the user interest information to the selected data collection vehicle through the server communicator 3100.

The server controller 3200 can include and store a vehicle, which agreed with interest data collection by a request from the server 3000 when a passenger initially boarded, in the vehicle list of the server storage 3300.

The server controller 3200 can receive an interest data collection manner selected by a passenger who boards on the data collection vehicle through the server communicator 3100 and can collect interest data in accordance with the received manner.

For example, a passenger of the data collection vehicle may select, as the interest data collection manner, a manner not collecting interest data while driving, may select a manner collecting interest data but disallowing a change of a route by the server 3000, or may select a manner collecting interest data and also allowing for a change of the route by the server 3000.

When a passenger of the data collection vehicle selects the manner collecting interest data and also allowing for a change of the route by the server 3000, the server controller 3200 can control the vehicle to receive confirmation of the passenger, to change the route of the vehicle, to be driven in accordance with existence of an interest data collection location close to the current route.

The server controller 3200 can generate a route control signal changing the route of the data collection vehicle on the basis of the reference about a data collection location and the reference about data collection time and can transmit the generated route control signal to the data collection vehicle through the server communicator 3100.

When the time taken by the data collection vehicle to arrive at a destination via a data collection location does not exceed the time that is taken to arrive at the destination through a predetermined route, the server controller 3200 can generate a route control signal changing the route such that the data collection vehicle arrives at the destination via the data collection location, and can transmit the generated route control signal to the data collection vehicle through the server communicator 3100.

When receiving confirmation from a passenger and changing the route of the vehicle for interest data collection, the server controller 3200 can generate an estimation model for a vehicle route change and determine whether to change the route of the vehicle for interest data collection in accordance with the generated estimation model by performing machine learning using a set of data, which includes vehicle route data and whether or not of allowance for a route change by the passenger, as learning data

The artificial intelligence (AI) is one field of computer science and information technology that studies methods to make computers mimic intelligent human behaviors such as reasoning, learning, self-improving and the like.

In addition, the artificial intelligence does not exist on its own, but is rather directly or indirectly related to a number of other fields in computer science. In recent years, there have been numerous attempts to introduce an element of AI into various fields of information technology to solve problems in the respective fields.

Machine learning is an area of artificial intelligence that includes the field of study that gives computers the capability to learn without being explicitly programmed.

Specifically, the machine learning can be a technology for researching and constructing a system for learning, predicting, and improving its own performance based on empirical data and an algorithm for the same. The algorithms of the Machine Learning take a method of constructing a specific model in order to obtain the prediction or the determination based on the input data, rather than performing the strictly defined static program instructions.

Many Machine Learning algorithms have been developed on how to classify data in the machine learning. Representative examples of such machine learning algorithms for data classification include a decision tree, a Bayesian network, a support vector machine (SVM), an artificial neural network (ANN), and so forth.

Decision tree refers to an analysis method that uses a tree-like graph or model of decision rules to perform classification and prediction.

Bayesian network may include a model that represents the probabilistic relationship (conditional independence) among a set of variables. Bayesian network may be appropriate for data mining via unsupervised learning.

SVM may include a supervised learning model for pattern detection and data analysis, heavily used in classification and regression analysis.

ANN is a data processing system modelled after the mechanism of biological neurons and interneuron connections, in which a number of neurons, referred to as nodes or processing elements, are interconnected in layers.

ANNs are models used in machine learning and may include statistical learning algorithms conceived from biological neural networks (particularly of the brain in the central nervous system of an animal) in machine learning and cognitive science.

ANNs may refer generally to models that have artificial neurons (nodes) forming a network through synaptic interconnections, and acquires problem-solving capability as the strengths of synaptic interconnections are adjusted throughout training.

The terms ‘artificial neural network’ and ‘neural network’ may be used interchangeably herein.

An ANN may include a number of layers, each including a number of neurons. In addition, the Artificial Neural Network can include the synapse for connecting between neuron and neuron.

An ANN may be defined by the following three factors: (1) a connection pattern between neurons on different layers; (2) a learning process that updates synaptic weights; and (3) an activation function generating an output value from a weighted sum of inputs received from a lower layer.

ANNs include, but are not limited to, network models such as a deep neural network (DNN), a recurrent neural network (RNN), a bidirectional recurrent deep neural network (BRDNN), a multilayer perception (MLP), and a convolutional neural network (CNN).

An ANN may be classified as a single-layer neural network or a multi-layer neural network, based on the number of layers therein.

In general, a single-layer neural network may include an input layer and an output layer.

Further, in general, a multi-layer neural network may include an input layer, one or more hidden layers, and an output layer.

The Input layer is a layer that accepts external data, the number of neurons in the Input layer is equal to the number of input variables, and the Hidden layer is disposed between the Input layer and the Output layer and receives a signal from the Input layer to extract the characteristics to transfer it to the Output layer. The output layer receives a signal from the hidden layer and outputs an output value based on the received signal. Input signals between the neurons are summed together after being multiplied by corresponding connection strengths (synaptic weights), and if this sum exceeds a threshold value of a corresponding neuron, the neuron can be activated and output an output value obtained through an activation function.

In the meantime, a deep neural network with a plurality of hidden layers between the input layer and the output layer may be the most representative type of artificial neural network which enables deep learning, which is one machine learning technique.

The Artificial Neural Network can be trained by using training data. Here, the training may refer to the process of determining parameters of the artificial neural network by using the training data, to perform tasks such as classification, regression analysis, and clustering of inputted data. Such parameters of the artificial neural network may include synaptic weights and biases applied to neurons.

An artificial neural network trained using training data can classify or cluster inputted data according to a pattern within the inputted data.

Throughout the present specification, an artificial neural network trained using training data may be referred to as a trained model.

Hereinbelow, learning paradigms of an artificial neural network will be described in detail.

Learning paradigms, in which an artificial neural network operates, may be classified into supervised learning, unsupervised learning, semi-supervised learning, and reinforcement learning.

Supervised learning is a machine learning method that derives a single function from the training data.

Among the functions that may be thus derived, a function that outputs a continuous range of values may be referred to as a regressor, and a function that predicts and outputs the class of an input vector may be referred to as a classifier.

In supervised learning, an artificial neural network can be trained with training data that has been given a label.

Here, the label may refer to a target answer (or a result value) to be guessed by the artificial neural network when the training data is inputted to the artificial neural network.

Throughout the present specification, the target answer (or a result value) to be guessed by the artificial neural network when the training data is inputted may be referred to as a label or labeling data.

Further, throughout the present specification, assigning one or more labels to training data in order to train an artificial neural network may be referred to as labeling the training data with labeling data.

Training data and labels corresponding to the training data together may form a single training set, and as such, they may be inputted to an artificial neural network as a training set.

The training data may exhibit a number of features, and the training data being labeled with the labels may be interpreted as the features exhibited by the training data being labeled with the labels. In this case, the training data may represent a feature of an input object as a vector.

Using training data and labeling data together, the artificial neural network may derive a correlation function between the training data and the labeling data. Then, through evaluation of the function derived from the artificial neural network, a parameter of the artificial neural network may be determined (optimized).

Unsupervised learning is a machine learning method that learns from training data that has not been given a label.

More specifically, unsupervised learning may be a training scheme that trains an artificial neural network to discover a pattern within given training data and perform classification by using the discovered pattern, rather than by using a correlation between given training data and labels corresponding to the given training data.

Examples of unsupervised learning include, but are not limited to, clustering and independent component analysis.

Examples of artificial neural networks using unsupervised learning include, but are not limited to, a generative adversarial network (GAN) and an autoencoder (AE).

GAN is a machine learning method in which two different artificial intelligences, a generator and a discriminator, improve performance through competing with each other.

The generator may be a model generating new data that generates new data based on true data.

The discriminator may be a model recognizing patterns in data that determines whether inputted data is from the true data or from the new data generated by the generator.

Furthermore, the generator may receive and learn from data that has failed to fool the discriminator, while the discriminator may receive and learn from data that has succeeded in fooling the discriminator. Accordingly, the generator may evolve so as to fool the discriminator as effectively as possible, while the discriminator evolves so as to distinguish, as effectively as possible, between the true data and the data generated by the generator.

An auto-encoder (AE) is a neural network which aims to reconstruct its input as output.

More specifically, AE may include an input layer, at least one hidden layer, and an output layer.

Since the number of nodes in the hidden layer is smaller than the number of nodes in the input layer, the dimensionality of data is reduced, thus leading to data compression or encoding.

Furthermore, the data outputted from the hidden layer may be inputted to the output layer. Given that the number of nodes in the output layer is greater than the number of nodes in the hidden layer, the dimensionality of the data increases, thus leading to data decompression or decoding.

Furthermore, in the AE, the inputted data is represented as hidden layer data as interneuron connection strengths are adjusted through training. The fact that when representing information, the hidden layer is able to reconstruct the inputted data as output by using fewer neurons than the input layer may indicate that the hidden layer has discovered a hidden pattern in the inputted data and is using the discovered hidden pattern to represent the information.

Semi-supervised learning is machine learning method that makes use of both labeled training data and unlabeled training data.

One semi-supervised learning technique involves reasoning the label of unlabeled training data, and then using this reasoned label for learning. This technique may be used advantageously when the cost associated with the labeling process is high.

Reinforcement learning may be based on a theory that given the condition under which a reinforcement learning agent can determine what action to choose at each time instance, the agent can find an optimal path to a solution solely based on experience without reference to data.

Reinforcement learning may be performed mainly through a Markov decision process (MDP).

Markov decision process consists of four stages: first, an agent is given a condition containing information required for performing a next action; second, how the agent behaves in the condition is defined; third, which actions the agent should choose to get rewards and which actions to choose to get penalties are defined; and fourth, the agent iterates until future reward is maximized, thereby deriving an optimal policy.

An artificial neural network is characterized by features of its model, the features including an activation function, a loss function or cost function, a learning algorithm, an optimization algorithm, and so forth. Also, the hyperparameters are set before learning, and model parameters can be set through learning to specify the architecture of the artificial neural network.

For instance, the structure of an artificial neural network may be determined by a number of factors, including the number of hidden layers, the number of hidden nodes included in each hidden layer, input feature vectors, target feature vectors, and so forth.

Hyperparameters may include various parameters which need to be initially set for learning, much like the initial values of model parameters. Also, the model parameters may include various parameters sought to be determined through learning.

For instance, the hyperparameters may include initial values of weights and biases between nodes, mini-batch size, iteration number, learning rate, and so forth. Furthermore, the model parameters may include a weight between nodes, a bias between nodes, and so forth.

Loss function may be used as an index (reference) in determining an optimal model parameter during the learning process of an artificial neural network. Learning in the artificial neural network involves a process of adjusting model parameters so as to reduce the loss function, and the purpose of learning may be to determine the model parameters that minimize the loss function.

Loss functions typically use means squared error (MSE) or cross entropy error (CEE), but the present disclosure is not limited thereto.

Cross-entropy error may be used when a true label is one-hot encoded. One-hot encoding may include an encoding method in which among given neurons, only those corresponding to a target answer are given 1 as a true label value, while those neurons that do not correspond to the target answer are given 0 as a true label value.

In machine learning or deep learning, learning optimization algorithms may be deployed to minimize a cost function, and examples of such learning optimization algorithms include gradient descent (GD), stochastic gradient descent (SGD), momentum, Nesterov accelerate gradient (NAG), Adagrad, AdaDelta, RMSProp, Adam, and Nadam.

GD includes a method that adjusts model parameters in a direction that decreases the output of a cost function by using a current slope of the cost function.

The direction in which the model parameters are to be adjusted may be referred to as a step direction, and a size by which the model parameters are to be adjusted may be referred to as a step size.

Here, the step size may mean a learning rate.

GD obtains a slope of the cost function through use of partial differential equations, using each of model parameters, and updates the model parameters by adjusting the model parameters by a learning rate in the direction of the slope.

SGD may include a method that separates the training dataset into mini batches, and by performing gradient descent for each of these mini batches, increases the frequency of gradient descent.

Adagrad, AdaDelta and RMSProp may include methods that increase optimization accuracy in SGD by adjusting the step size, and may also include methods that increase optimization accuracy in SGD by adjusting the momentum and step direction. Adam may include a method that combines momentum and RMSProp and increases optimization accuracy in SGD by adjusting the step size and step direction. Nadam may include a method that combines NAG and RMSProp and increases optimization accuracy by adjusting the step size and step direction.

Learning rate and accuracy of an artificial neural network rely not only on the structure and learning optimization algorithms of the artificial neural network but also on the hyperparameters thereof. Therefore, in order to obtain a good learning model, it is important to choose a proper structure and learning algorithms for the artificial neural network, but also to choose proper hyperparameters.

In general, the artificial neural network is first trained by experimentally setting hyperparameters to various values, and based on the results of training, the hyperparameters can be set to optimal values that provide a stable learning rate and accuracy.

The server controller 3200 may be implemented by using at least one of an application specific integrated circuit (ASIC), a digital signal processor (DSP), a digital signal processing device (DSP), a programmable logic device (PLD), a field programmable gate array (FPGA), a processor, a controller, a micro-controller, a microprocessor, or other electronic units for performing other functions.

The server storage 3300 is electrically connected with the server controller 3200. The server storage 3300 can store basic data of each part of an apparatus for collecting user interest information, control data for operation control of the parts of the apparatus for collecting user interest information, and input/output data.

The server storage 3300 can store a plurality of vehicle lists that agreed with collection of interest data and can provide the stored data to the server controller 3200 by control of the server controller 3200.

The server storage 3300 can store an estimation model machine-learned to estimate whether or not of changing the route of the vehicle 1000 for interest data collection.

The server storage 3300 may be various storage devices such as a ROM, a RAM, an EPROM, a flash drive, and a hard drive, in terms of hardware. The server storage 3300 can store programs for processing or controlling of the server controller 3200. The server storage 3300 may be integrally formed with the server controller 3200, or implemented as a sub-component of the server controller 3200.

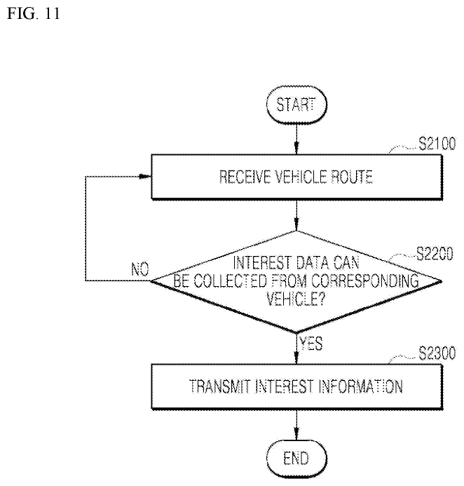

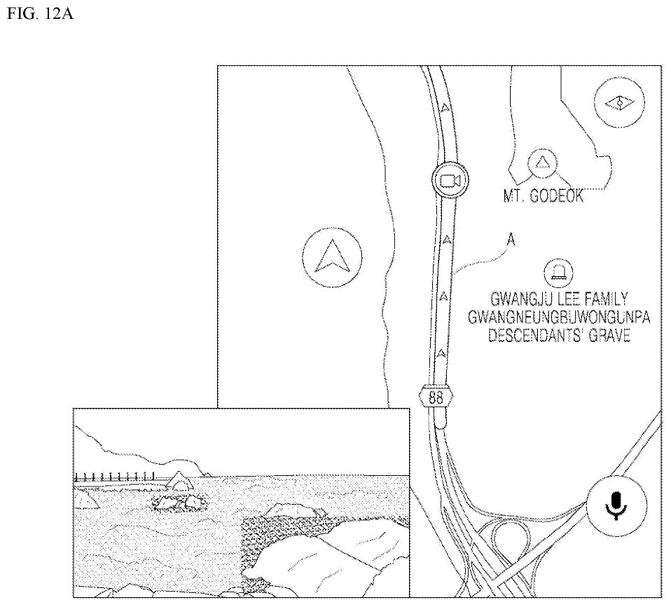

FIGS. 10 and 11 are operation flowcharts showing a method for collecting user interest information according to an embodiment of the present disclosure.

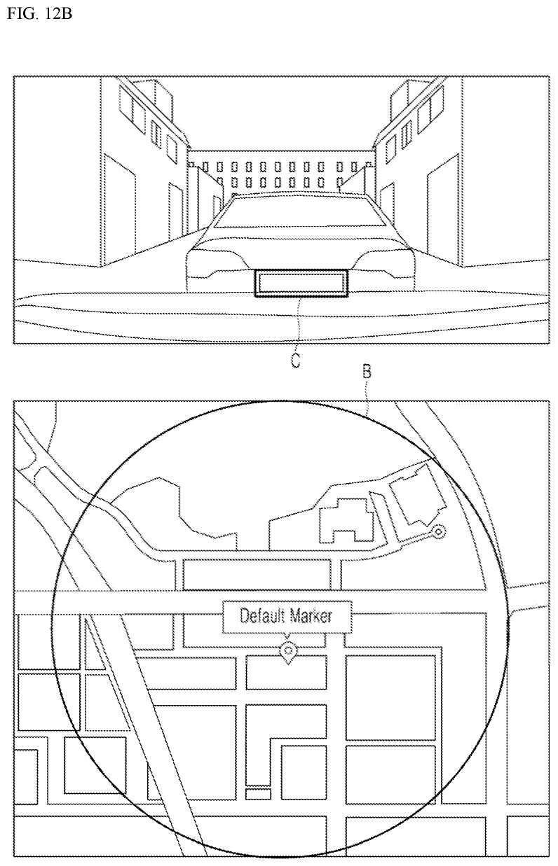

FIGS. 12A and 12B are diagrams showing an interface image of an apparatus for collecting user interest information according to an embodiment of the present disclosure.

The operations of the method for collecting user interest information according to an embodiment of the present disclosure and the apparatus for collecting user interest information according to an embodiment of the present disclosure are described hereafter with reference to FIG. 10 to FIG. 12B.

Referring to FIG. 10, the vehicle controller 1200 can receive user interest information through the vehicle communicator 1100 (S1100).

The user interest information is generated by the server 3000 and an example of the architecture of the user interest information is as follows.

The user interest information may include references about a data collection location, data collection time, and collection data type.

The data collection location may include a predetermined location, a predetermined section of a road reference, and an area within a predetermined radius from a predetermined location and may be set as any places to be able to collect data at any places without a limitation in location. When interest data is set such that data are collected at any places without a limitation in location, the vehicle controller 1200 can acquire sensor data through the object detector 1400 upon starting of the vehicle 1000 and can select all of the acquired sensor data as interest data.

The data collection time may include predetermined time or may be set to be able to collect data anytime without a limitation in time.

The user interest information may include a reference about the number of times of data collection or an upper limit of the size of collection data instead of the data collection time.

The collection data type may be full data including a sound, an image, and a location or data including object-related patterns, for example, a sound including a bird sound, wave sound, a voice, a wind sound, a horn sound, etc., or an image including a license number of a vehicle, a bicycle, a person, a sign, a predetermined color, a predetermined shape, etc., and may be set such that all sounds or images are collected without a limitation in object.

Further, the collection data type may include GPS information, for example, location information such as GPS altitude for checking a sink hole, a bump, a road state (a state requiring repair due to aging), a sharp curve, etc. and may be set such that all data are collected without limitation in location information.

The vehicle controller 1200 can set a data collection range on the basis of user interest information (S1200). For example, the vehicle controller 1200 can set a data collection range such that the reference about the collection location of user interest information is the east coast highway, the reference about the data collection time is time for which the size of collected data is 100 Mbyte or less, and the reference about the collection data type is a wave sound that is an object type.

The vehicle controller 1200 can collect interest data by selecting interest data from sensor data in accordance with the data collection range (S1300).

For example, the vehicle controller 1200 can collect by selecting a wave sound, which is acquired through the object detector 1400 or a microphone module of the user interface 1300 while driving along the east coast highway A, as interest data, as shown in FIG. 12A.

On the other hand, when the reference about the collection data type of user interest information is a coast that is an object type for finding out a place for filming, the vehicle controller 1200, as shown in FIG. 12A, can collect by selecting all of an image and a sound acquired through the object detector 1400 or the user interface 1300 while driving along the east coast highway as interest data.

The vehicle controller 1200 can determine whether interest data includes private information (S1400). For example, the vehicle controller 1200, as shown in FIG. 12B, can determine whether a vehicle license plate C corresponding to private information is included in an image including a vehicle collected in a predetermined area B.

When interest data includes private information, the vehicle controller 1200 can generate anonymized anonymous interest data, for example, data with the vehicle license plate C removed (S1500) and can transmit the generated anonymous interest data to the external server 3000 through the vehicle communicator 1100. That is, the vehicle controller 1200 can check whether private information is included in interest data and can mask the checked private information.

When interest data does not include private information, the vehicle controller 1200 can transmit the interest data to the external server 3000 through the vehicle communicator 1100 without masking private information (S1600).

Referring to FIG. 11, the server controller 3200 can check vehicles expected to pass a location, a section, or an area where interest data can be collected, by receiving routes of a plurality of vehicle including the vehicle 1000 through the server communicator 3100 (S2100).

The server controller 3200 can determine whether interest data can be collected for vehicles expected to pass a location, a section, or an area where interest data can be collected, for example, whether it is the case when a passenger in a corresponding vehicle has selected a manner collecting interest data as an interest data collection manner but disallowing a change of the route by the server 3000 or the case when the passenger has selected a manner collecting interest data and also allowing for a change of the route by the server 3000 (S2200).

When it is impossible to collect interest data for vehicles expected to a location, a section, or an area where interest data can be collected, for example, when a passenger in a corresponding vehicle has selected not selecting interest data during the current driving as an interest data collection manner, it is possible to find out again vehicles expected to pass a location where interest data can be collected, by receiving again the routes of a plurality of vehicles (S2100).

When it is possible to collect interest data for vehicles expected to a location, a section, or an area where interest data can be collected, the vehicle controller 3200 can transmit user interest information to the vehicles through the server communicator 3100 (S2300).

The present disclosure described above can be embodied as computer-readable codes on a medium on which a program is recorded. The computer readable medium includes all types of recording devices in which data readable by a computer system readable can be stored. Examples of the computer readable medium include a hard disk drive (HDD), a solid state disk (SSD), a silicon disk drive (SDD), a read-only memory (ROM), a random-access memory (RAM), CD-ROM, a magnetic tape, a floppy disk, an optical data storage device, and the like, and it may also be implemented in the form of a carrier wave (for example, transmission over the Internet). In addition, the computer may include a processor or a controller. Therefore, the above description should not be construed as limiting and should be considered illustrative. The scope of the present disclosure should be determined by rational interpretation of the appended claims, and all changes within the scope of equivalents of the present disclosure are included in the scope of the present disclosure.

What is claimed is:

1. An apparatus for collecting user interest information which is provided with user interest information from an external server, the apparatus comprising:
an object detector configured to acquire sensor data;
a communicator configured to receive the user interest information; and
a controller configured to set a data collection range on the basis of the user interest information, and select interest data from the sensor data in accordance with the data collection range,
wherein the controller transmits the interest data to the external server through the communicator, and
the user interest information is information expressed as an architecture including a reference about data collection location, a reference about data collection time, and a reference about a collection data type on the basis of an interest field input by a user.

2. The apparatus of claim 1, wherein the controller generates anonymous interest data obtained by anonymizing private information in the interest data and transmits the generated anonymous interest data to the external server through the communicator.

3. The apparatus of claim 1, wherein when the collection data type is an object type and the object type is included in the sensor data, the controller selects the sensor data as the interest data.

4. The apparatus of claim 1, wherein the communicator receives the user interest information on the basis of a downlink grant of a 5G network to which a vehicle is connected to operate in an autonomous driving mode.

5. An apparatus for collecting user interest information which is provided with interest data from a plurality of vehicles, the apparatus comprising:
a communicator configured to receive an interest field input by a user, to transmit the user interest information corresponding to the interest field input by the user, and to receive the interest data corresponding to the user interest information; and
a controller configured to generate the user interest information expressed as an architecture including a reference about data collection location, a reference about data collection time, and a reference about a collection data type on the basis of the interest field input by the user, and to provide the generated user interest information to the communicator.

6. The apparatus of claim 5, further comprising a storage configured to store a plurality of vehicle lists that agreed with collection of the interest data,
wherein the controller selects a data collection vehicle for interest data collection from a plurality of vehicles included in the plurality of vehicle lists on the basis of the reference about the data collection location and the reference about the data collection time and transmits the user interest information to the selected data collection vehicle through the communicator.

7. The apparatus of claim 6, wherein the controller generates a route control signal changing a route of the data collection vehicle on the basis of the reference about the data collection location and the reference about the data collection time and transmits the generated route control signal to the data collection vehicle through the communicator.

8. The apparatus of claim 6, wherein when time taken by the data collection vehicle to arrive at a destination via the data collection location does not exceed time that is taken to arrive at the destination through a predetermined route, the controller generates a route control signal changing a route such that the data collection vehicle arrives at the destination via the data collection location, and transmits the generated route control signal to the data collection vehicle through the communicator.

9. A method for collecting user interest information which is provided with user interest information from an external server, the method comprising:
receiving user interest information;
setting a data collection range on the basis of the user interest information;
acquiring sensor data; and
selecting interest data from the sensor data in accordance with the data collection range,
wherein the user interest information is information expressed as an architecture including a reference about data collection location, a reference about data collection time, and a reference about a collection data type on the basis of an interest field input by a user.

10. The method of claim 9, further comprising:
generating anonymous interest data obtained by anonymizing private information in the interest data; and
transmitting the anonymous interest data to the external server.

11. The method of claim 9, wherein when the collection data type is an object type and the object type is included in the sensor data, the selecting of interest data includes selecting the sensor data as the interest data.

12. The method of claim 9, wherein the receiving of user interest information includes receiving the user interest information on the basis of a downlink grant of a 5G network to which a vehicle is connected to operate in an autonomous driving mode.

13. A method for collecting user interest information which is provided with interest data from a plurality of vehicles, the method comprising:
receiving an interest field input by a user;
generating the user interest information expressed as an architecture including a reference about data collection location, a reference about data collection time, and a reference about a collection data type on the basis of the interest field input by the user;
transmitting the user interest information; and
receiving the interest data corresponding to the user interest information.

14. The method of claim 13, further comprising:
storing a plurality of vehicle lists that agreed with collection of the interest data; and
selecting a data collection vehicle for interest data collection from a plurality of vehicles included in the plurality of vehicle lists on the basis of the reference about the data collection location and the reference about the data collection time,
wherein the transmitting of the user interest information includes transmitting the user interest information to the data collection vehicle.

15. The method of claim 14, further comprising generating a route control signal changing a route of the data collection vehicle on the basis of the reference about the data collection location and the reference about the data collection time and transmitting the generated route control signal to the data collection vehicle.

16. The method of claim 14, further comprising, when time taken by the data collection vehicle to arrive at a destination via the data collection location does not exceed time that is taken to arrive at the destination through a predetermined route, generating a route control signal changing a route such that the data collection vehicle arrives at the destination via the data collection location, and transmits the generated route control signal to the data collection vehicle.

17. A computer-readable recording medium in which an user interest information collection program is recorded, the user interest information collection program causing a computer to perform:
acquiring sensor data;
receiving user interest information;
setting a data collection range on the basis of the user interest information; and
selecting interest data from the sensor data in accordance with the data collection range,
wherein the user interest information is information expressed as an architecture including a reference about data collection location, a reference about data collection time, and a reference about a collection data type on the basis of an interest field input by a user.

18. A computer-readable recording medium in which an user interest information collection program is recorded, the user interest information collection program causing a computer to perform:
receiving an interest field input by a user;
generating the user interest information expressed as an architecture including a reference about data collection location, a reference about data collection time, and a reference about a collection data type on the basis of the interest field input by the user;
transmitting the user interest information; and
receiving interest data corresponding to the user interest information.
